(19) United States
(12) Patent Application Publication
(10) Pub. No.: US 2024/0087293 A1
(43) Pub. Date: Mar. 14, 2024

(54) EXTRACTING FEATURES FROM SENSOR DATA

(71) Applicant: Five Al Limited, Cambridge (GB)

(72) Inventors: John Redford, Cambridge (GB); Sina Samangooei, Cambridge (GB); Anuj Sharma, Cambridge (GB); Puneet Dokania, Cambridge (GB)

(73) Assignee: Five Al Limited, Cambridge (GB)

(21) Appl. No.: 18/272,950

(22) PCT Filed: Jan. 19, 2022
(86) PCT No.: PCT/EP2022/051147

§ 371 Date: Jul. 18, 2023

(30) Foreign Application Priority Data
Jan. 20, 2021 (GB) 2100732.3

(51) Int. Cl. G06V 10/77; G06V 10/774; G06V 10/82

(52) U.S. Cl. CPC G06V 10/7715; G06V 10/774; G06V 10/82

(57) ABSTRACT

A computer implemented method of training an encoder to extract features from sensor data comprises training a machine learning (ML) system based on a self-supervised loss function applied to a training set, the ML system comprising the encoder. The training set comprises sets of real sensor data and corresponding sets of synthetic sensor data. The encoder extracts features from each set of real and synthetic sensor data, and the self-supervised loss function encourages the ML system to associate each set of real sensor data with its corresponding set of synthetic sensor data based on their respective features.

### TECHNICAL FIELD

The present disclosure pertains generally to feature extraction, and in particular to training methods that can learn to extract useful features from sensor data, as well as trained feature extractors that can be applied to sensor data.

### BACKGROUND

Broadly speaking, supervised machine learning (ML) aims to learn some function given only examples pairs of inputs and outputs (\tilde{x}, \tilde{y}) (the training set {(\tilde{x}, \tilde{y})}). Here, “\tilde{x}” is a training input, and “\tilde{y}” is variously termed a label, annotation or ground truth. Denoting an ML model as ƒ(x; w), the model computes an output y=ƒ(x; w) for some input x based on a set of learned parameters w. During training, the aim is to learn values of the parameters w that substantially match the outputs of the ML model, y=ƒ(\tilde{x}; w), to the labels, \tilde{y}, across the training set {(\tilde{x}, \tilde{y})}. The model is said to generalize from the training set, in that, once trained, it can be meaningfully applied to an unlabelled input not encountered during training.

A broad application of ML is perception. Perception means the interpretation of sensor data of one or more modalities, such as image, radar and/or lidar. Perception includes object recognition tasks, such as object detection, object localization and class or instance segmentation. Such tasks can, for example, facilitate the understanding of complex multi-object scenes captured in sensor data. Computer-implemented perception tasks are widely applicable across a range of technical fields. For example, perception is a critical component of autonomous vehicle (AV) systems and advanced driver-assistance systems (ADAS).

State-of-the-art performance on computer-implemented perception tasks has been achieved via machine learning (ML), with many key performance gains attributed to deep convolutional neural networks (CNNs) trained on very large data sets.

Computer vision (CV)—the interpretation of image data—is a subset of perception. Recent years have seen material developments in ML applied to image recognition and other CV tasks. A key benchmark is provided by the ImageNet database, containing millions of images annotated with object classes. Breakthrough performance on the ImageNet challenge was achieved by AlexNet in 2012, a convolutional neural network (CNN) trained on GPU hardware. Since then, CNN architectures have continued to set the bar for state-of-the-art performance for image classification tasks.

A challenge with CNNs and deep networks is the need for large amounts of training data—typically hundreds of thousands or millions of annotated training images are needed to achieve state-of-the-art performance. Moreover, the complexity of the training data increases with the complexity of the task to be learned: for basic image classification (classifying whole images), simple class labels are sufficient; but more involved tasks require more complex annotation, such as annotated bounding boxes for object recognition or per-pixel classifications for image segmentation.

“Shared learning” techniques, such as transfer learning or multi-task learning, go some way to addressing these issues. Shared learning seeks to share learned knowledge across multiple tasks. For example, this may involve the learning of robust feature representations of sensor data (features) that are shared between multiple tasks. Learning of such feature representations may be referred to as “representation learning” or “feature learning”.

In transfer learning, an ML system is initially trained on a first task (the “pre-training” or “pretext” phase), and subsequently trained on a second task in a way that incorporates knowledge learned in the training on the first task (“fine-tuning”). Feature leaning occurs in the pre-training phase, and the learned features are used to learn and perform the second task. The first task may be referred to as a “dummy” task because it is often the second task (the desired task) that is of interest in this context. An ML system might comprise a first component, variously termed the encoder, body or feature extractor, and a second component, sometimes termed the head. In high-level terms, the encoder receives an input (such as an image or images), processes the input to extract features, and passes the features to the head, which in turn processes those features in order to compute an output. In pre-training, the encoder may be connected to a “dummy” head, and the dummy head and the encoder might be trained simultaneously on the dummy task using annotated training inputs commensurate with the dummy task. In pre-training, the aim is to match the outputs of the dummy head to the annotations. In computer vision, that first task might be a simple image classification task; although this will generally require a large volume of training data, the form of annotation (per-image class labels) is relatively simple, reducing the annotation burden. Because the encoder and the head are trained simultaneously, it is not only parameters of the head that that are optimized—the encoder also learns parameters for extracting optimal features for the classification task at hand (a form of feature learning). After pre-training, the dummy head might be discarded, and the now-trained encoder connected to a new and as-yet untrained head. In fine turning, the encoder parameters learned in pre-training on the dummy task (e.g., image classification) may be frozen, with only the parameters of the new head being optimised on the desired second task. The desired task could, for example, be an object detection task such as object localization, e.g., bounding box detection (predicting bounding boxes around objects), or image segmentation (predicting individual object pixels), requiring annotated 2D bounding boxes (or object localization ground truth more generally) and annotated segmentation masks respectively. Although the features have been learned through training on the dummy task, the assumption is that, by choosing an appropriate dummy task, the knowledge encoded in the pre-trained encoder weights should be largely applicable to the desired task as well; the features extracted by the pre-trained encoder should, therefore, be useful to the new head in performing the desired task, significantly reducing the amount of training data required to train the new head. For example, once a network has been pre-trained on a suitable classification task, it can be fine-tuned to bounding box detection or image segmentation with only a relatively small number of annotated bounding boxes or annotated segmentation masks. The effectiveness of transfer learning in image processing has been demonstrated on various image processing tasks in recent years.

Multi-task learning is another shared learning approach. Rather than separating pre-training from fine-tuning, in multi-task learning, a machine learning system is trained simultaneously on multiple tasks. In practice, this typically involves some shared encoder architecture—for example, a dummy head and a desired head may each be connected to a shared encoder, with the heads and the encoder trained simultaneously on dummy and desired tasks though optimization of an appropriate multi-task loss.

It will be appreciated that the terms “dummy” and “desired” are merely convenient labels—the terminology does not necessarily imply that the dummy task is trivial or useless (that may or may not be the case). Rather, all that terminology implies some mechanism (including but not limited to transfer learning and multitask learning) by which knowledge learned in training on some first task (the dummy task) is shared in the learning of some second task (the desired task). In this context, the term “feature learning” refers to the training of the encoder (whether through pre-training on the encoder and dummy head, multi-task training on the encoder, dummy head and desired head simultaneously or some any other shared learning approach in which encoder parameters are learned).

In computer vision, many developments in transfer learning have leveraged supervised pre-training on large, manually annotated image sets such as ImageNet. There are various examples of successful transfer learning approaches with ImageNet features; that is, features learned from the 14 million or so “generic” images in the ImageNet database that have been manually annotated in respect of over 20,000 image classes. However, despite those successes, supervised feature learning approaches are inherently limited in their reliance on manually annotated features.

“Self-supervised” approaches seek to address these issues. Self-supervised learning mirrors the framework of supervised learning, but with the aim of removing or reducing the need for manual annotations by deriving the ground truth, \tilde{y}, for the dummy task automatically, i.e., given a set of training inputs {\tilde{x}}, to automatically generate a training set {(\tilde{x}, \tilde{y})} for the dummy task without manual annotation. Outside of perception, an example of a successful self-supervised approach is the Word2Vec model the field of Natural Language Processing (NLP). In training, each input, \tilde{x}, is a word taken from a training document, and the ground truth, \tilde{y}, is derived automatically as a set of adjacent words; in training the task is, therefore, to learn to predict likely adjacent words given an input word. This approach has been demonstrated to be highly effective at learning semantically rich features for words that can then be applied to other tasks such as document classification.

Whilst self-supervised feature-learning tasks have also been explored in computer vision, they have been largely unable to match the performance of pre-training on the manually annotated ImageNet images.

The “SimCLR” architecture is a recent and promising development in self-supervised feature learning for computer vision. For further details, see “A Simple Framework for Contrastive Learning of Visual Representations”, Chen et. al. (2020); arXiv:2002.05709, incorporated herein by reference in its entirety. SimCLR adopts a “contrastive learning” approach, where training data is generated automatically via image transformations. A stochastic data augmentation module transforms a given image randomly resulting in two correlated “views” of the image, \tilde{x}ᵢ and \tilde{x}ⱼ. Those views are said to be “associated” and constitute a “positive pair”. The training also uses “negative” image pairs that are not expected to have any particular association with each other. The self-supervised task is that of identifying positive pairs. That task is encoded in a contrastive loss function that encourages the network to extract similar features for two images of a positive pair, whilst discouraging similarity of features for two images of a negative pair.

### SUMMARY

To date, the pair generation functions considered in contrastive learning have been relatively primitive. These typically involve basic geometric transformations (such as random cropping, rotation, rescaling etc.) or other transformation such as the addition of random noise or colour distortion.

The present disclosure uses a combination of real and synthetic sensor data for feature learning. Real inputs and corresponding synthetic inputs are used. A pretext task of matching the real inputs with their synthetic counterparts is constructed. In training, this forces an encoder to “look beyond” the discrepancies between real and synthetic senor data and identify higher-level semantic features common to both. This feature learning method leverages the domain gap between real and synthetic sensor data.

According to a first aspect herein, a computer implemented method of training an encoder to extract features from sensor data comprises:
training a machine learning (ML) system based on a self-supervised loss function applied to a training set, the ML system comprising the encoder;
wherein the training set comprises sets of real sensor data and corresponding sets of synthetic sensor data, wherein the encoder extracts features from each set of real and synthetic sensor data, and the self-supervised loss function encourages the ML system to associate each set of real sensor data with its corresponding set of synthetic sensor data based on their respective features.

Each set of sensor data can be encoded for processing by the encoder using any suitable data representation (which may be determined, at least in part, by the architecture of the encoder).

Herein, the term data representation refers to some lower-level representation of the sensor data or some transformed version thereof, and includes, for example, image, point cloud, voxel or mesh representations and the like. The term “input” is used as shorthand for such a data representation unless otherwise indicated. By contrast, a feature representation refers to some higher-level representation extracted by the encoder. When the term representation is used without modification, the meaning shall be apparent from the context. Terms such as feature learning and representation learning are used as shorthand to refer to the training of the encoder based on the dummy task unless otherwise indicated.

In embodiments, each set of real sensor data may comprise sensor data of at least one sensor modality, and the method may comprise generating the corresponding sets of synthetic sensor data using one or more sensor models for the at least one sensor modality.

The method may comprise: receiving at least one time-sequence of real sensor data; processing the at least one time-sequence to extract a description of a scenario; and simulating the scenario in a simulator. Each set of real sensor data may comprise a portion of real sensor data of the at least one time-sequence, and the corresponding set of synthetic sensor data may be derived from a corresponding part of the simulated scenario using the one or more sensor models.

Each set of real sensor data may capture a real static scene at a time instant in the real sensor data sequence, and the corresponding set of synthetic sensor data may capture a synthetic static scene at a corresponding time instant in the simulation.

At least one of the sets of real sensor data may comprise a real image, and the corresponding set of synthetic sensor data may comprise a corresponding synthetic image derived via image rendering.

At least one of the sets of real sensor data may comprise a real lidar or radar point cloud, and the corresponding set of synthetic sensor data may comprise a corresponding synthetic point cloud derived via lidar or radar modelling.

The ML system may comprise a trainable projection component which projects the features from a feature space into a projection space, and the self-supervised loss may be defined on the projected features. The trainable projection component may be trained simultaneously with the encoder.

The sets of real sensor data may capture real static or dynamic driving scenes, and the corresponding sets of synthetic sensor data may capture corresponding synthetic static or dynamic driving scenes.

A second aspect herein provides an encoder trained in accordance with the method of the first aspect or any embodiment thereof.

A third aspect herein provides a computer system comprising such an encoder and a perception component. The encoder is configured to receive an input sensor data representation and extract features therefrom, and the perception component is configured to use the extracted features to interpret the input sensor data representation.

A fourth aspect herein provides a training computer program configured, when executed on one or more computer processors, to implement the method of the first aspect or any embodiment thereof.

### BRIEF DESCRIPTION OF FIGURES

For a better understanding of the present disclosure, and to show how embodiments of the same may be carried into effect, reference is made by way of example only to the following figures in which:

FIG. 1 shows a schematic block diagram of a system for generating paired training inputs;

FIG. 2 shows a schematic block diagram of a contrastive learning pretext training architecture;

FIG. 3 shows a schematic block diagram for an interleaved training architecture; and

FIG. 4 shows a schematic block diagram of a computer system configured to implement a trained encoder.

### DETAILED DESCRIPTION

As discussed, shared learning approaches seek to learn feature representations that generalize to other tasks. The following examples consider a contrastive learning pretext task of associating real inputs with their synthetic counterparts.

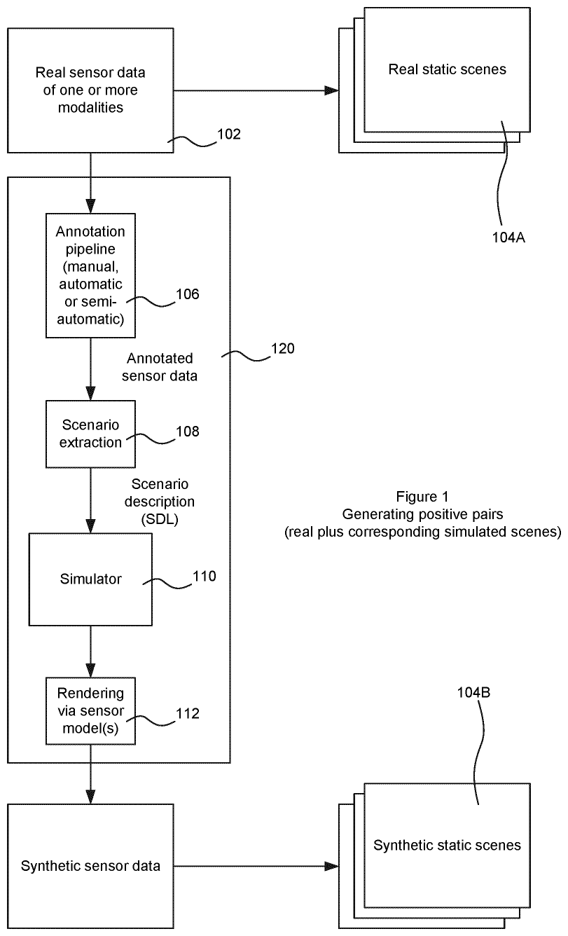

FIG. 1 shows a schematic block diagram of a system for generating training inputs for a contrastive learning pretext task.

Reference numeral 102 denotes a set of real sensor data captured using one or more physical sensors. The following examples consider sensor data captured from a sensor equipped vehicle such as image, lidar or radar data, or any combination of those modalities. The sensor data 102 can be encoded in any suitable way, e.g., using an image, voxel, point cloud or surface mesh representation etc. or any combination thereof.

The sensor data 102 could for example take the form of a video sequence or some other sequence of sensor data captured over some time interval. The sensor data 102 thus captures a dynamic scene that might change over the duration of that time interval as the sensor-equipped vehicle moves or objects within the dynamic scene change or move.

A static scene is a snapshot of the dynamic scene at some time instant. The following examples consider a contrastive learning task of identifying real and simulated representations of the same static scene. For the purpose of this contrastive learning task, the real and simulated representations of that scene are associated in the above sense and constitute a positive pair of pretext training inputs. The following examples consider complex multi-object scenes of the kind that might be encountered in a driving context.

Reference numeral 104A denotes a representation of a real static scene within the sensor data 102, referred to as a real scene 104A for conciseness. Reference number 104B denotes a representation of a simulated (synthetic) version of the same scene, referred to as a simulated scene 104B for conciseness.

FIG. 1 shows multiple real static scenes of the sensor data 102. A corresponding synthetic scene is generated for each of those real static scenes.

The static scenes 104A, 104B may or may not be represented in the same way as the sensor data 102. For example, the real sensor data 102 could comprise a 3D point cloud, and the static scene could be a discretised 2D image representation of the 3D point cloud. A 2D image representation does not necessarily exclude the presence of explicitly encoded 3D spatial information. For example, a PIXOR representation of a 3D point cloud is a bird's-eye-view (BEV) image representation of that uses occupancy values to indicate the presence or absence of a corresponding point in the point cloud and, in some case, height values to fully represent the points of the point cloud (similar to the depth channel of an RGBD image). For further details, see Yang et al, “PIXOR: Real-time 3D Object Detection from Point Clouds”, arXiv:1902.06326, which is incorporated herein by reference in its entirety.

The following examples consider image representations of static scenes. However, it will be appreciated that the description applies equally to other sensor data representations such as point clouds, voxel representation, surface meshes etc.

In order to generate the corresponding synthetic scene 104B, the sensor data 102 is processed in a processing pipeline 120. In the following examples, it is assumed that the sensor data 102 captures 3D spatial information (in whatever form). Within an annotation pipeline 106, objects captured within the images are annotated and identified, via 3D annotation or a combination of both. This can be a manual, semi-automatic or fully automatic annotation process. From the annotations, a scenario description can be extracted by a scenario extraction component 108. For example, the scenario description may be formulated in a scenario description language (SDL). The scenario description is, in turn, passed to a 3D multibody simulator 110. This allows the dynamic scene captured in the sensor data 102 to be recreated in the simulator 110. Finally, for each real scene 104A, the corresponding synthetic scene 104B is rendered by a rendering component 112 at the corresponding time instant in the 3D multibody simulation. For images, a rendering technique such as raycasting or raytracing can be used to render an image of the simulated scene at that time instant.

Scene extraction for the purpose of simulation and testing is known in the field of autonomous driving and advanced driver assist systems. A processing pipeline 120 of the kind depicted in FIG. 1 would typically be used to extract scenes from sensor data in a form conducive to simulation for the purpose of testing or training. Further details of the processing pipeline 120 are therefore omitted. A benefit of the present techniques is that they can leverage existing scene extraction architecture for the purpose of representation learning. Moreover, features learned using the described techniques can potentially address practical issues that arise in the context of simulation testing, as described below in further detail.

Whilst the above examples consider “full” 3D scene reconstruction, synthetic scenes can be generated using simpler techniques. What is germane is that the real and simulated scenes 104A, 104B sufficiently correspond to the same scene to allow them to be identified as a positive pair in pre-training. That is to say, what matters is that the synthetic inputs are semantically coherent with their real counterparts.

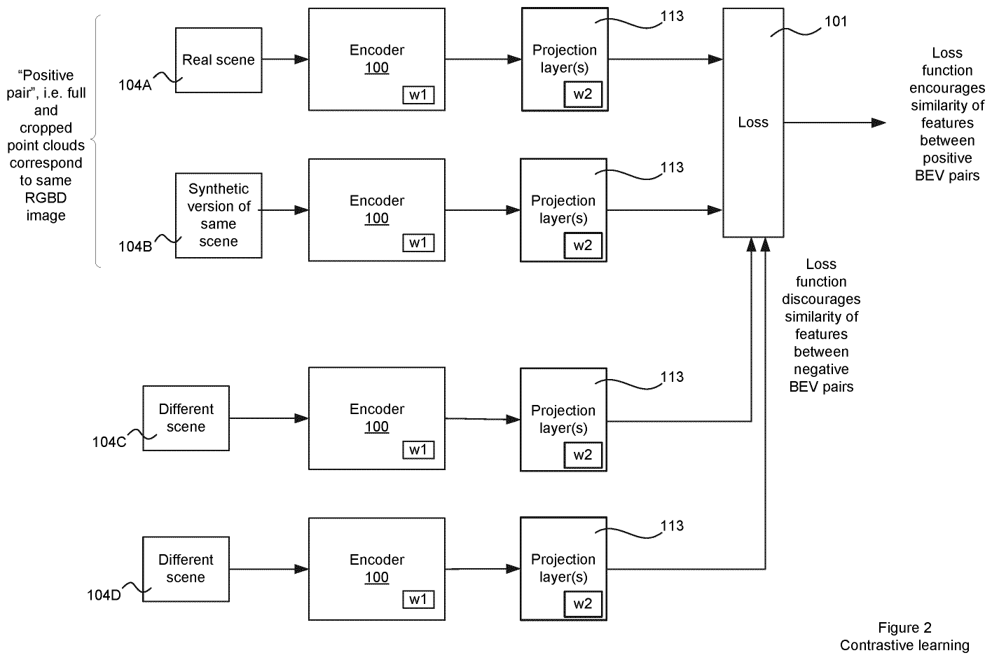

FIG. 2 shows a schematic block diagram of a contrastive learning architecture applied to real and synthetic images generated according to the principles of FIG. 1. An encoder 100 receives an image (real or synthetic) as input and processes the input image based on a set of encoder weights w₁. In a pre-training phase, the encoder weights w₁ are learned via pre-training on a pretext contrastive learning task.

For the contrastive learning task, FIG. 1 depicts first and second images 104A, 104B that are real and simulated versions of the same scene respectively. The first and second images 104A, 104B therefore constitute a positive pair, as depicted in the top part of FIG. 2. Images that do not correspond to the same scene constitute negative pairs. The bottom part of FIG. 2 depicts third and fourth images 104C, 104D, which are not associated with each other or with the first and second images 104A, 104B. For the four images 104A,104B, 104C,104D depicted in FIG. 2, there are five negative pairs: the first image 104A paired with either one of the third and fourth images 104C, 104D, the second image 104B paired with either one of those images 104C, 104D and the third and fourth images 104C, 104D paired with each other. The aim of the contrastive learning task is to identify positive pairs whilst distinguishing negative pairs. Each image 104A, 104B, 104C, 104D is processed by the encoder 100 based on the encoder weights w₁ in order to extract a set of features therefrom. A contrastive learning loss 101 is defined which encourages similarity of features between positively paired images whilst discouraging similarity of features between negatively paired images.

A projection component 113 projects features extracted by the encoder 102 from a feature space into a projection space to obtain first and second feature projections for the first and second images 1304A, 1304B respectively. The projection component 113 is implemented as one or more layers with projection weights w₂. The encoder weights w₁ and projection weights w₂ are learned simultaneously with each other in training on the pretext task. The projection component 113 can be implemented as a single layer with projection weights w₂. Whilst a single layer is sufficient, multiples layers can be used.

When positive image pairs are generated according to FIG. 1, the encoder 100 is encouraged to extract similar features for real and simulated representations of the same scene 104A, 104B. This exploits the fact that the rendering process used to generate the synthetic scene 104B is imperfect. The above examples consider image rendering, but the same principles apply to other modelling techniques such as techniques for synthesizing radar or lidar data. Contrastive learning encourages the encoder to extract similar features for the paired real and synthetic images 104A, 104B. Therefore, the pretext task encourages the encoder to “look beyond” the differences between real and synthetic sensor data, and assign features based on the higher-level aspects of the static scene that are common to both. In a sense, the encoder 100 is encouraged to interpret the real and simulated scene 104A, 104B at a similar level to the scenario description language used to describe the scene for the purpose of simulation.

The SimCLR approach of Chen et al. can be applied with positive/negative image pairs generated in accordance with FIG. 1. Following the notation of Chen et al., a pretext training set is denoted {\tilde{x}ₖ} and a positive pair of images is denoted \tilde{x}ᵢ, \tilde{x}ⱼ. The encoder 100 is represented mathematically as a function ƒ(⋅). For a CNN encoder architecture, ƒ typically involves a series of convolutions and non-linear transformations applied in accordance with the encoder weights w₁. The output representation of the encoder 100 is denoted hᵢ=ƒ(\tilde{x}ᵢ) for a given input \tilde{x}ᵢ. The projection component 113 is implemented as small neural network projection head g(⋅) that transforms the representation into a space in which the contrastive loss 101 is applied (the projection space). The contrastive loss is defined between a given positive pair \tilde{x}ᵢ, \tilde{x}ⱼ in minibatch of 2N images as:

$$\\ \begin{matrix}{ℓ}_{i , j} = - log \frac{exp ( sim ( {𝓏}_{i} , {𝓏}_{j} ) / τ )}{{\sum }_{k = 1}^{2 N} {𝟙}_{[ k \neq i ]} exp ( sim ( {𝓏}_{i} , {𝓏}_{k} ) / τ )} , & ( 1 )\end{matrix}$$

where zᵢ=g (hᵢ), τ is a constant, sim(u, v)=u^{T}v/∥u∥∥v∥ denotes the dot product between l₂ normalized u and v and an indicator function [symbol] [k≠i] is 1 if k≠j and 0 otherwise. For pre-training, the loss is computed across all positive pairs in {\tilde{x}ₖ}, with the numerator in Equation (1) acting to encourage similarity of features between positively paired images \tilde{x}ᵢ, \tilde{x}ⱼ, and the denominator acting to discourage similarity of features between \tilde{x}ᵢ and all other images. The loss function of Equation 1 is a normalized temperature-scaled cross-entropy loss (NT-Xent). As will be appreciated, this is just one example of a viable contrastive loss that can be applied with paired images generated as per FIG. 1. Other contrastive learning approaches can be applied to paired images generated according to the present teaching.

Referring to FIG. 2, when \tilde{x}ᵢ is the real scene 104A, the corresponding simulated scene 104B would be \tilde{x}ⱼ; the real image 104A paired with the third image 104C and the real scene 104A paired the fourth image 104D are negative pairs that contribute to the summation over negative pairs in the denominator for \tilde{x}ᵢ.

A benefit of the described approach is that it makes the encoder 100 less sensitive to discrepancies between real and synthetic data: by definition, the encoder 100 performs well when it assigns similar features to a real input and its synthetic counterpart.

This increased robustness is relevant, for example, in simulation-based testing of AV and ADAS components. Simulation is widely recognized as a vital tool for testing the performance of AV and ADAS stacks. There are various approaches to simulation testing. Full-stack testing via photorealistic/sensor realistic simulation is one approach. Synthetic sensor data generated using sensor model(s) feeds into a perception system of the stack, which processes the synthetic sensor data as it would real sensor data and provides perception outputs to higher level components of the stack (e.g., prediction, motion planning etc.). For the results to be useful, the synthetic sensor data needs to be sufficiently realistic to cause the same response in the perception system as real-world data.

One problem is that certain perception components, such as Convolutional Neural Networks (CNNs) trained using existing methods, are particularly sensitive to the quality of the simulated data. Although it is possible to generate high quality simulated image data, the CNNs in perception are extremely sensitive to even the minutest deviations from real data. Here, the issue is a high degree of sensitivity to small discrepancies.

Another problem is that certain types of sensor data are hard to model. Thus, even a perception system that is not particularly sensitive to the quality of the input data will give poor results, e.g., RADAR falls into the category of sensor data that is difficult to synthesise. This is because the physics of RADAR is inherently hard to model. Here, the issue is that the discrepancies between the real and synthetic data are large even for state-of-the-art sensor models.

The techniques here can potentially mitigate these issues because the pretext training makes the encoder 100 less sensitive to the discrepancies between real and simulated data. A perception system that incorporates the encoder 100 may, therefore, perform more reliably on synthetic sensor data (i.e., more closely matching its performance on real sensor data)—particularly if the discrepancies between the real and synthetic sensor data encountered in feature learning are similar to the discrepancies in subsequent simulation-based testing (whether or not those discrepancies are small or large). This, in turn, means that the perception system may be more conducive to simulation-based testing. Using the techniques herein, an AV or other robotic perception system can thus be designed that achieves a required level of performance on real data, whilst also being more suited to simulation-based testing before it is deployed at scale in the real world.

The present techniques can be implemented using existing data sets that are already available. For example, the KITTI vision benchmark suit contains large quantities of high-resolution images captured from sensor-equipped vehicles (available at www.cvlibs.net/datasets/kitti at the time of writing). The more recent Virtual KITTI 2 Dataset provides a photo-realistic synthetic version of the KITTI dataset (see Cabon et al. “Virtual KITTI 2” (2020), arXiv:2001.10773). Real-synthetic positive pairs could be generated for contrastive learning, e.g., by pairing real images or video sequences from the KITTI dataset with their synthetic counterparts in Virtual KITTI 2.

Note that the term “synthetic” herein does not necessarily imply photorealism or sensor-realism. Synthetic sensor data that might be considered “poor quality” in other contexts can still be useful in the present context if it is semantically coherent with its real counterpart. Indeed, larger discrepancies between the real and simulated sensor data are potentially beneficial because larger discrepancies force the encoder 100 to look for “higher-level” semantic similarities between real and synthetic inputs.

The simulator 110 is a computer program that provides a three-dimensional environmental model which reflects the physical environment that a vehicle may operate in. In a driving context, the 3D environmental model defines at least the road network on which an autonomous vehicle is intended to operate, and other actors in the environment.

The rendering component 112 provides a sensor simulation system which models one or more types of sensor with which a vehicle may be equipped (e.g., camera, radar, lidar etc.).

Synthetic sensor data is generated using one or more sensor models, i.e., based on known physics of a sensor system(s) to be modelled. Such techniques generally involve constructing a 3D model of a scene (e.g., in the simulator 110) and modelling the physics of relevant signals interacting with the 3D model of the scene. For a camera or camera system, this typically models rays within a spectrum detectable to the camera. For example, synthetic images can be rendered using raytracing, raycasting or other image rendering techniques. Lidar can be similarly modelled via tracing of a laser beam(s) emitted by a lidar system and propagated through the 3D-model of the scene. Radar can be similarly modelled based on the known physical properties of radio waves transmitted and detected by a radar system.

As noted, the described techniques can be applied to any sensor data representation, such as image or voxel representations, point clouds in 2D or 3D space etc. Training input can also comprise sensor data of multiple modalities, e.g., point clouds and images, or fused point clouds of different modalities. Unless otherwise indicated, the term “3D image” refers to a 2D image representation that explicitly encodes 3D spatial information. Examples of such 3D images include depth images (with or without colour channel(s)), RGBD images and the like.

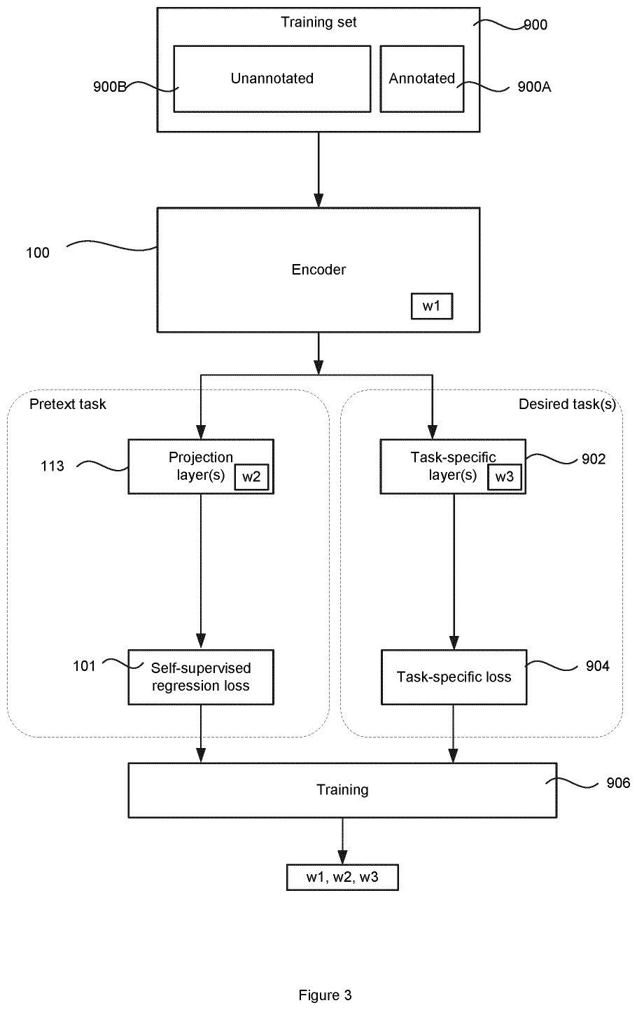

FIG. 3 shows an example of a possible training architecture. In this example, instead of separate pre-training/fine-tuning phases, the training on the pretext task and the training on a desired task are interleaved. The pretext and desired tasks are trained 900 on a common training set in this example. However, only a relatively small subset 900A of the training set 900 is annotated with ground truth for the desired task (e.g., ground truth bounding boxes derived via manual annotation); the remaining subset 900B is unannotated and is only used for the self-supervised pretext training. The encoder 100 is shown connected to the projection layer(s) 113 as in FIG. 1. Additionally, the encoder 100 is also connected to one or more task-specific layer(s) 902 of a desired head, having learnable task-specific weights w₃. A conventional supervised loss 904 may be defined on the desired task(s), with the aim of minimizing the task-specific loss 904 with respect to the annotated subset 900A of the training data 900. A training component 906 is shown, which implements the training method as follows.

Training is performed in a sequence of training steps, each having two phases. In the first phase of each training step, a single update is applied the encoder weights w₁ and projection weights w₂ with the aim of optimizing the self-supervised pretext loss 101 over the full training set 900; then, in the second phase, a single update is applied to the task-specific weights w₃ with the aim of optimizing the task-specific loss 904 over the annotated subset 900A of the training set 900. In the second phase, the encoder weights w₁ may be frozen, or the encoder weights w₁ may be updated for a second time based on the task-specific loss 904, simultaneously with the task-specific weights w₃. In this manner, the task-specific training is “interleaved” with the pretext training.

As will be appreciated, this is just one example of a suitable shared learning training scheme. Alternatively, the encoder 100 and projection layer(s) 113 could be trained in an initial pre-training phase, followed by a fine-tuning phase in which the task-specific layer(s) 902 are trained. Alternatively, a multi-task loss could be constructed that combines the pretext and task-specific losses 101, 904 and all of the weights w₁, w₂, w₃ could be learned simultaneously though optimization of the multi-task loss.

Gradient descent (or ascent) is one example of a suitable training method that may be used.

In the above examples, the projection layer(s) 113 is learned, in the sense of having projection weights w₂ that are learned simultaneously with the encoder weights w₁ during training on the pretext task. The projection layer(s) 113 does not form part of the encoder 100 and the projection weights w₂ may be discarded once pretext training is complete. This architecture is useful to prevent the encoder weights w₁ from becoming overly sensitive to the pretext task. However, this may be context dependent and, in some cases, it may be possible to achieve good encoder performance with no projection layers. In a neural network architecture, the projection layer(s) 113 are any layer(s) that are discarded after pretext training (or, more precisely, which are not used for the purpose of the desired task(s)), and the encoder 100 means the remaining layers before the discarded/unused layer(s).

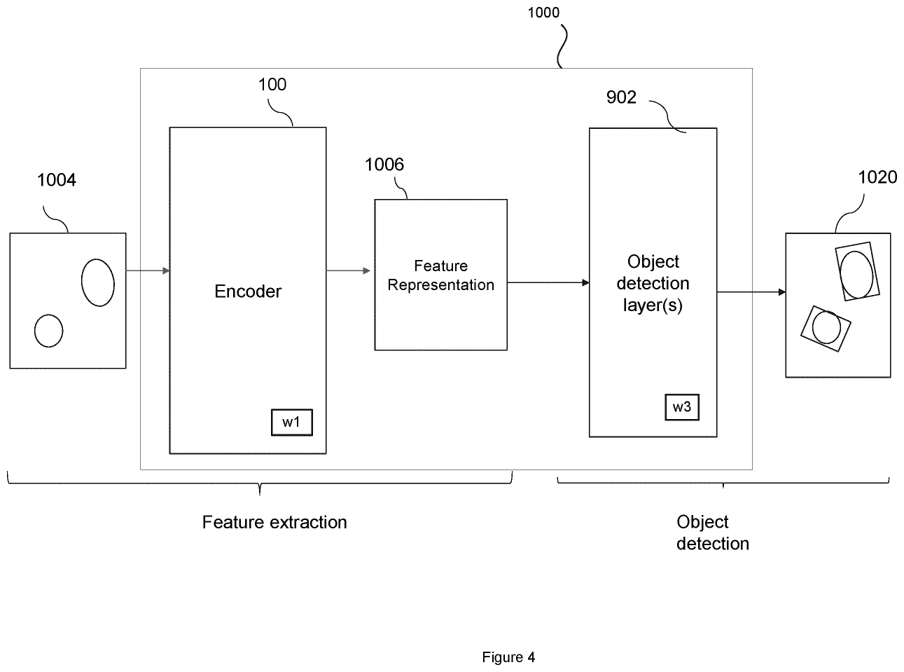

FIG. 4 shows a computer system 1000 configured to implement the trained encoder 100 for a bounding box detection task. An input image or other data representation 1004 is input to the trained encoder 100. A feature representation 1006 is extracted by the trained encoder 100 and passed to the trained task-specific layer(s) 902, which have been trained as a bounding box detector in this example. The encoder 100 and task-specific layers 902 operate on their inputs as described above in the context of training. The difference is that the weights w₁, w₃ have been learned by this point such that the encoder 100 and object detector 902 are now performing useful tasks. The task-specific layer(s) 902 output a set of object predictions, in the form of predicted bounding boxes 1020. It will be appreciated this is merely one example of a practical application of the trained encoder 100. The task-specific layers 902 can be trained to use the features for any desired task.

The feature representation 1006 represents features in the same way as training. For example, during training and in the trained system, extracted features may be contained in a feature map having F-channels (the dimensionality of the feature space). Such a feature map encodes local features that corresponds to respective regions of the original input (e.g., pixels, points, 2D or 3D grid cells, or areas/volumes more generally).

Whilst FIG. 4 considers a bounding box detector 902, this is merely one example of a perception component that can use extracted features. Examples of perception methods include object or scene classification, orientation or position detection (with or without box detection or extent detection more generally), instance or class segmentation etc., any of which can be implemented using feature representations learned in accordance with the present teaching.

Herein, the term “perception” refers generally to methods for recognizing patterns exhibited in sensor data representations, such as images, point clouds, voxel representations, mesh representations etc. State-of-the-art perception methods are typically ML-based, and many state-of-the art perception method use deep convolutional neural networks (CNNs). Pattern recognition has a wide range of applications including object detection/localization, object/scene recognition/classification, instance segmentation etc.

Object detection and object localization are used interchangeably herein to refer to techniques for locating objects in point clouds and other data representations in a broad sense; this includes 2D or 3D bounding box detection, but also encompasses the detection of object location and/or object pose (with or without full bounding box detection), and the identification of object clusters. Object detection/localization may or may not additionally classify objects that have been located (for the avoidance of doubt, whilst, in the field of machine leaning, the term “object detection” sometimes implies that bounding boxes are detected and additionally labelled with object classes, the term is used in a broader sense herein that does not necessarily imply object classification or bounding box detection).

References herein to components, functions, modules and the like, denote functional components of a computer system which may be implemented at the hardware level in various ways. This includes the encoder 100, the projection layer(s) 113, the task-specific layer(s) 902, the training component 906 and the other components depicted in FIGS. 1 to 4. Such components may be implemented in a suitably configured computer system. A computer system comprises one or more computers that may be programmable or non-programmable. A computer comprises one or more processors which carry out the functionality of the aforementioned functional components. A processor can take the form of a general-purpose processor such as a CPU (Central Processing unit) or accelerator (e.g. GPU) etc. or more specialized form of hardware processor such as an FPGA (Field Programmable Gate Array) or ASIC (Application-Specific Integrated Circuit). That is, a processor may be programmable (e.g. an instruction-based general-purpose processor, FPGA etc.) or non-programmable (e.g. an ASIC). Such a computer system may be implemented in an onboard or offboard context in the context of fully/semi-autonomous vehicles and mobile robots. Training may be performed in the same or a different computer system to that in which the trained components are deployed. Training of modern deep networks will typically be carried out using GPUs or other accelerator processors.

References is made to ML models, such as CNNs or other neural networks. This terminology refers to a component (software, hardware, or any combination thereof) configured to implement ML techniques.

1. A computer implemented method of training an encoder to extract features from sensor data, the method comprising:
training a machine learning (ML) system based on a self-supervised loss function applied to a training set, the ML system comprising the encoder;
wherein the training set comprises sets of real sensor data and corresponding sets of synthetic sensor data, wherein the encoder extracts features from each set of real and synthetic sensor data, and the self-supervised loss function encourages the ML system to associate each set of real sensor data with its corresponding set of synthetic sensor data based on their respective features.

2. The method of claim 1, wherein each set of real sensor data comprises sensor data of at least one sensor modality, the method comprising:
generating the corresponding sets of synthetic sensor data using one or more sensor models for the at least one sensor modality.

3. The method of claim 2, comprising:
receiving at least one time-sequence of real sensor data;
processing the at least one time-sequence to extract a description of a scenario; and
simulating the scenario in a simulator, wherein each set of real sensor data comprises a portion of real sensor data of the at least one time-sequence, and the corresponding set of synthetic sensor data is derived from a corresponding part of the simulated scenario using the one or more sensor models.

4. The method of claim 3, wherein each set of real sensor data captures a real static scene at a time instant in the real sensor data sequence, and the corresponding set of synthetic sensor data captures a synthetic static scene at a corresponding time instant in the simulation.

5. The method of claim 4, wherein each real and static scene is a discretised 2D image representation of a 3D point cloud.

6. The method of claim 2, wherein for each real set of sensor data the corresponding set of synthetic sensor data is generated via processing of the real set of sensor data.

7. The method of claim 1, wherein at least one of the sets of real sensor data comprises a real image, and the corresponding set of synthetic sensor data comprises a corresponding synthetic image derived via image rendering.

8. The method of claim 1, wherein at least one of the sets of real sensor data comprises a real lidar or radar point cloud, and the corresponding set of synthetic sensor data comprises a corresponding synthetic point cloud derived via lidar or radar modelling.

9. The method of claim 8, wherein each point cloud is represented in the form of a discretised 2D image.

10. The method of claim 1, wherein the ML system comprises a trainable projection component which projects the features from a feature space into a projection space, the self-supervised loss defined on the projected features, wherein the trainable projection component is trained simultaneously with the encoder.

11. The method of claim 1, wherein the sets of real sensor data capture real static or dynamic driving scenes, and the corresponding sets of synthetic sensor data capture corresponding synthetic static or dynamic driving scenes.

12. The method of claim 1, wherein the self-supervised loss function is a contrastive loss function that encourages similarity of features between positive pair, each positive pair being a set of real sensor data and its corresponding set of synthetic sensor data, whilst discouraging similarity of features between negative pairs of real sensor data and synthetic sensor data that do not correspond to each other.

13. (canceled)

14. A computer system comprising:
at least one memory configured to store computer-readable instructions;
at least one hardware processor coupled to the at least one memory and configured to execute the computer-readable instructions, which upon execution cause the at least one hardware processor to train a machine learning (ML) system based on a self-supervised loss function applied to a training set, the ML system comprising an encoder; wherein the training set comprises sets of real sensor data and corresponding sets of synthetic sensor data, wherein the encoder is configured to extract features from each set of real and synthetic sensor data, and the self-supervised loss function is configured to encourage the ML system to associate each set of real sensor data with its corresponding set of synthetic sensor data based on their respective features; and
a perception component;
wherein the encoder is configured to receive an input sensor data representation and extract features therefrom, and the perception component is configured to use the extracted features to interpret the input sensor data representation.

15. A non-transitory medium embodying computer-readable instructions configured, when executed on one or more hardware processors, to train an encoder to extract features from sensor data by:
training a machine learning (ML) system based on a self-supervised loss function applied to a training set, the ML system comprising the encoder;
wherein the training set comprises sets of real sensor data and corresponding sets of synthetic sensor data, wherein the encoder extracts features from each set of real and synthetic sensor data, and the self-supervised loss function encourages the ML system to associate each set of real sensor data with its corresponding set of synthetic sensor data based on their respective features.

16. The computer system of claim 14, wherein each set of real sensor data comprises sensor data of at least one sensor modality, and the corresponding sets of synthetic sensor data are generated using one or more sensor models for the at least one sensor modality

17. The computer system of claim 16, wherein the system is configured to:
process the at least one time-sequence to extract a description of a scenario; and
simulate the scenario in a simulator, wherein each set of real sensor data comprises a portion of real sensor data of the at least one time-sequence, and the corresponding set of synthetic sensor data is derived from a corresponding part of the simulated scenario using the one or more sensor models.

18. The computer system of claim 17, wherein each set of real sensor data captures a real static scene at a time instant in the real sensor data sequence, and the corresponding set of synthetic sensor data captures a synthetic static scene at a corresponding time instant in the simulation.

19. The computer system of claim 18, wherein each real and static scene is a discretised 2D image representation of a 3D point cloud.

20. The computer system of claim 16, wherein for each real set of sensor data the corresponding set of synthetic sensor data is generated via processing of the real set of sensor data.

21. The computer system of claim 14, wherein at least one of the sets of real sensor data comprises a real image, and the corresponding set of synthetic sensor data comprises a corresponding synthetic image derived via image rendering.
